(19) United States
(12) Patent Application Publication
(10) Pub. No.: US 2009/0251442 A1
(43) Pub. Date: Oct. 8, 2009

(54) ELECTRONIC STYLUS PEN WITH WEIGHT ADJUSTING MECHANISM

(75) Inventor: Takaaki Nakata, Saitama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Wacom Co., Ltd., Saitama-ken (JP)

(21) Appl. No.: 12/415,942

(22) Filed: Mar. 31, 2009

(30) Foreign Application Priority Data
Apr. 1, 2008 (JP) 2008-095416

(51) Int. Cl. G06F 3/033

(52) U.S. Cl. 345/179

(57) ABSTRACT

An electronic stylus pen with weight adjusting mechanism has a pen body (1); a stepped portion (3) arranged in the central portion of the pen body (1); a pen tip (5) arranged at a tip end of the pen body (1); and a small-diameter portion (4) arranged in an area between the stepped portion (3) and the pen tip (5) of the pen body (1). The diameter of the small-diameter portion (4) is smaller than that of the pen body (1). Weight adjusting members (6) are mounted at arbitrary positions of the small-diameter portion (4).

### CROSS REFERENCES TO RELATED APPLICATIONS

The present application claims priority under 35 U.S.C. § 119 from Japanese Patent Application JP 2008-095416 filed in the Japanese Patent Office on Apr. 1, 2008, the entire contents of which being incorporated herein by reference.

### BACKGROUND OF THE INVENTION

1. Field of the Invention

The present invention relates to an electronic stylus pen with weight adjusting mechanism.

2. Description of the Related Art

There has been proposed an input device with liquid crystal display function, in which input operation performed by an electronic stylus pen on a tablet digitizer is detected based on electromagnetic induction (see Japanese Unexamined Patent Application Publication No. 2005-275381). Such an input device with liquid crystal display function can also be applied in electronic devices, such as a PC (personal computer), a PDA (personal digital assistant) and the like.

The position of the center of gravity and the weight of an electronic stylus pen used in a digitizer are predetermined according to relevant standards and/or design conditions of the digitizer.

### SUMMARY OF THE INVENTION

If the user of a digitizer is a designer, sometimes he or she has to use the electronic stylus pen for a long time. Thus, it is desirable to develop an electronic stylus pen whose grip feeling, weight and the like can be adjusted according to the user's preference, so that input operation can be performed more easily.

However, in the art disclosed in Japanese Unexamined Patent Application Publication No. 2005-275381, since the position of the center of gravity and the weight of the electronic stylus pen are fixed, the grip feeling, weight and the like of the electronic stylus pen cannot be adjusted according to the user's preference. Thus, operability of such an electronic stylus pen is less than desirable.

In view of the aforesaid problems, in one aspect, the present invention is directed to providing an electronic stylus pen with weight adjusting mechanism in which the position of the center of gravity and the weight of the electronic stylus pen can be adjusted according to the user's preference, to thereby improve operability of the electronic stylus pen.

In one embodiment, an electronic stylus pen with weight adjusting mechanism includes one or more weight adjusting members; and an elongate (rod-like) pen body having a mounting portion to which one or more of the weight adjusting members are detachably mounted at arbitrary positions of the mounting portion.

It is preferred that the aforesaid electronic stylus pen with weight adjusting mechanism further includes: a pen tip arranged on one end of the pen body in longitudinal direction; and a regulating portion for regulating movement of the weight adjusting members in the longitudinal direction of the pen body, wherein the mounting portion is arranged between the regulating portion and the pen tip. Further, it is preferred that the aforesaid electronic stylus pen with weight adjusting mechanism further includes a covering portion for fixing (securing) the weight adjusting members by covering the mounting portion and the weight adjusting members. Further, it is preferred that, in the aforesaid electronic stylus pen with weight adjusting mechanism, the diameter of the mounting portion is smaller than that of the remaining portion of the pen body.

Further, it is preferred that, in the aforesaid electronic stylus pen with weight adjusting mechanism, the weight adjusting members include a plurality of weighting members and dummy members. Further, it is preferred that, in the aforesaid electronic stylus pen with weight adjusting mechanism, the position of the center of gravity of the pen body can be changed by combining the plurality of weighting members and dummy members. Further, it is preferred that, in the aforesaid electronic stylus pen with weight adjusting mechanism, the weight adjusting members are wrapped around or fitted on the mounting portion. Further, it is preferred that, in the aforesaid electronic stylus pen with weight adjusting mechanism, the covering portion is integrated with the weight adjusting members and can be attached to and detached from the mounting portion. Further, it is preferred that, in the aforesaid electronic stylus pen with weight adjusting mechanism, the weight adjusting members comprise a liquid or granular weight adjusting member that is filled into the covering portion.

Further, it is preferred that, in the aforesaid electronic stylus pen with weight adjusting mechanism, the weight adjusting members are made of materials which do not affect the function of the pen tip. In other words, in the aforesaid electronic stylus pen with weight adjusting mechanism, the pen tip is provided with a magnetic core, and the weight adjusting members are made of materials which do not interfere with electromagnetic induction effect caused by the magnetic core.

According to the present invention, it is possible to adjust the position of the center of gravity and the weight of the electronic stylus pen according to the user's preference by employing the weight adjusting member, and therefore operability of the electronic stylus pen can be improved.

### BRIEF DESCRIPTION OF THE DRAWINGS

FIG. 1A and FIG. 1B show the configuration of an electronic stylus pen with weight adjusting mechanism according to an embodiment of the present invention, wherein FIG. 1A is an overall view, and FIG. 1B is an exploded view;

FIG. 2 is a perspective view illustrating how to mount tubular weight adjusting members;

FIG. 3A and FIG. 3B show an adjustment example 1, in which the center of gravity of the pen is moved closer to the pen tip side, wherein FIG. 3A shows the adjustment example 1, and FIG. 3B shows the center of gravity of the pen and the weight of the weight adjusting members;

FIG. 4A and FIG. 4B show an adjustment example 2, in which the center of gravity of the pen is moved closer to the pen tip side while the weight of the pen is increased, wherein FIG. 4A shows the adjustment example 2, and FIG. 4B shows the center of gravity of the pen and the weight of the weight adjusting members;

FIG. 5A and FIG. 5B show an adjustment example 3, in which neither the center of gravity of the pen or the weight of the pen is adjusted, wherein FIG. 5A shows the adjustment example 3, and FIG. 5B shows the center of gravity of the pen and the weight of the weight adjusting members;

FIG. 6 is a perspective view showing a mounting state of wrapping-type weight adjusting members;

FIG. 7 is a perspective view showing a mounting state of fitting-type weight adjusting members;

FIG. 8 is a perspective view showing an example in which weight adjusting members are formed integrally with a pen grip inside the pen grip.

FIG. 9 is a perspective view showing an example in which weight adjusting members are formed integrally with the pen grip outside the pen grip;

FIG. 10 is a perspective view showing an example in which a liquid or granular weight adjusting member is filled into a tubular cavity of the pen grip; and

FIG. 11 is a perspective view showing an example in which a liquid or granular weight adjusting member is filled into a plurality of tubular cavities of the pen grip.

### DETAILED DESCRIPTION OF THE PREFERRED EMBODIMENT(S)

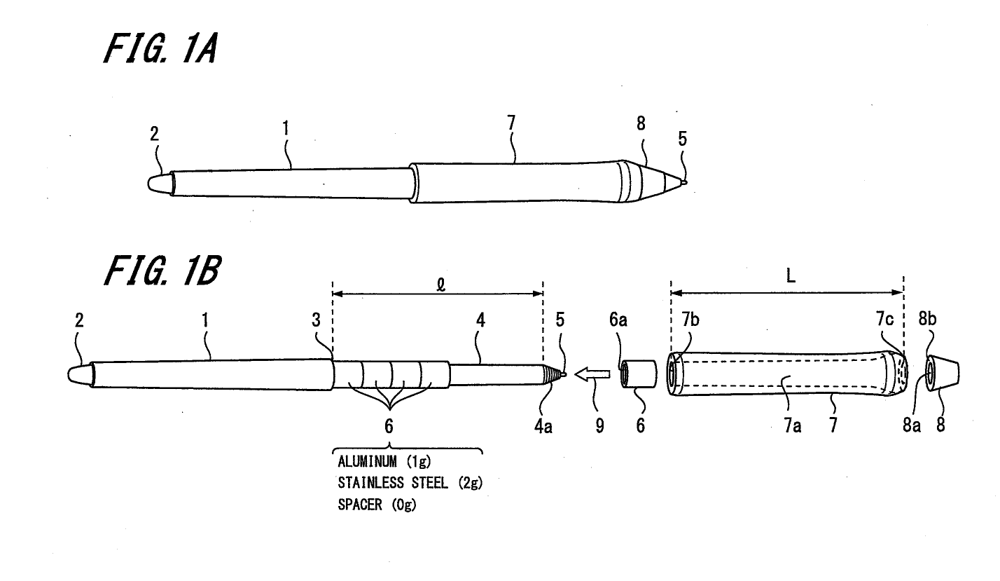

Various embodiments of the present invention will be described below with reference to FIGS. 1A to 11.

First, the configuration of an electronic stylus pen with weight adjusting mechanism according to one embodiment will be described below with reference to FIG. 1A and FIG. 1B.

The electronic stylus pen with weight adjusting mechanism according to the present embodiment includes a pen body 1, a plurality of weight adjusting members 6, a pen grip 7 and a cap 8. The pen body 1 includes a stepped portion 3, a pen tip 5 provided at a tip end portion of the pen body 1, and a pen tail 2.

The stepped portion 3 is arranged substantially in a central portion of the entire length (from the pen tail 2 to the pen tip 5) of the pen body 1, and the length of the stepped portion 3 in the radial direction is equal to or greater than the thickness of the weight adjusting member 6 (which is to be described later) in the radial direction.

The pen body 1 is provided, in an area between the stepped portion 3 and the pen tip 5 thereof, with a small-diameter portion 4 whose diameter is smaller than that of the remaining portion of the pen body 1 that ranges between the stepped portion 3 and the pen tail 2, and the weight adjusting members 6 are mounted at arbitrary positions of the small-diameter portion 4. Further, the small-diameter portion 4 is provided, on a pen tip 5 side thereof, with a tapered portion 4a that tapers off toward the pen tip 5, and the tapered portion 4a has an external thread formed on an outer surface thereof.

The weight adjusting members 6 each are a substantially cylindrical member having a through-hole 6a whose diameter is substantially equal to that of the small-diameter portion 4, so that the weight adjusting members 6 can be fitted (see arrow “9”) onto the small-diameter portion 4 in a direction from the side of the pen tip 5 to the side of the pen tail 2. Further, the weight adjusting members 6 each have a predetermined length (in the longitudinal direction of the pen body 1), and are composed of a plurality of weighting members such as aluminums (1 g), stainless steels (2 g), for example, and dummy members, such as spacers (0 g). The weight of the spacer (0 g) can be ignored compared with the weight of the aluminum (1 g), stainless steel (2 g) and the like.

The pen grip 7 is, for example, an elastic tubular rubber member for securing (fixing) the weight adjusting members 6 to the small-diameter portion 4 of the pen body 1. The pen grip 7 has a through-hole 7a, an opening 7b and an opening 7c. Further, the length L of the pen grip 7 is substantially equal to the length 1 of the small-diameter portion 4.

The cap 8 is a substantially cone-shaped member having a through-hole 8a. The cap 8 has an inner thread (not shown) formed on the inner wall of the through-hole 8a thereof. The diameter of a bottom 8b of the cap 8 is substantially equal to or greater than the diameter of the weight adjusting members 6, so that the weight adjusting members 6 do not fall off of the side of the pen tip 5. The inner wall of the through-hole 8a of the cap 8 is formed with the inner thread (not shown) for engaging the cap 8 to the pen body 1.

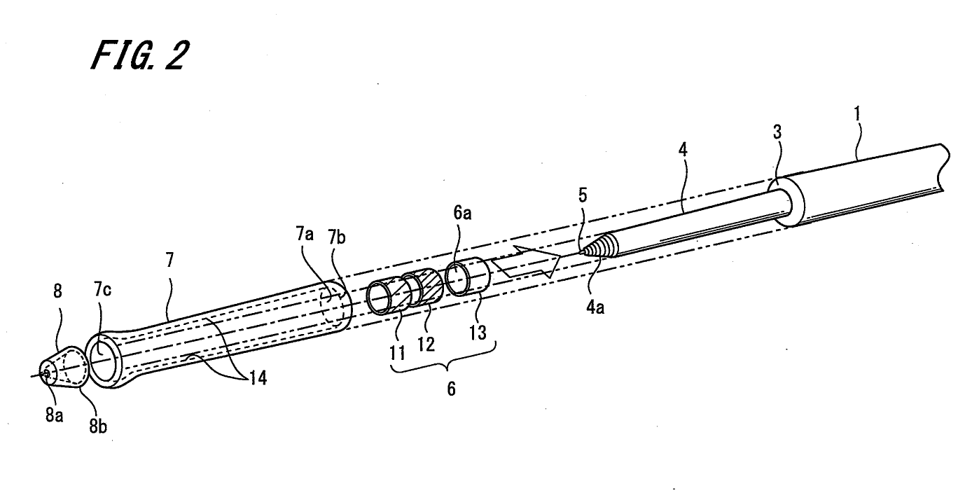

Next, an assembling method of the electronic stylus pen with weight adjusting mechanism according to the present embodiment will be described below with reference to FIG. 2. Incidentally, FIG. 2 exemplifies a case where one aluminum 11, one stainless steel 12 and one spacer 13 are selected as the weight adjusting members 6 to be mounted to the small-diameter portion 4 of the pen body 1.

First, one or more weight adjusting members 6 are selected by the user so that a desired weight is obtained. Next, of the selected weight adjusting members 6, the through-hole 6a of the weight adjusting member 6 intended to be disposed closest to the central portion of the pen body 1 is firstly fitted onto the small-diameter portion 4 of the pen body 1. In the same manner, the other selected weight adjusting members 6 are also fitted onto the small-diameter portion 4 sequentially. At this time, since the weight adjusting member 6 (the spacer 13) firstly fitted onto the small-diameter portion 4 abuts the stepped portion 3, the weight adjusting members 6 are regulated (constrained) not to move toward the side of the pen tail 2 more deeply. Incidentally, in the present embodiment, the weight adjusting members 6 are fitted in the order of: spacer 13, stainless steel 12 and aluminum 11.

Next, the small-diameter portion 4 having the weight adjusting members 6 fitted thereon is inserted into the through-hole 7a of the pen grip 7 from the opening 7b opened on one side of the pen grip 7, so that the weight adjusting members 6 fitted onto the small-diameter portion 4 are covered by the pen grip 7. At this time, the aluminum 11, the stainless steel 12 and the spacer 13 mounted at the arbitrary positions by the user are fixed in such positions by a fixing portion 14 (i.e., the inner wall of the through-hole 7a of the pen grip 7).

When the small-diameter portion 4 is inserted into the pen grip 7 until the opening 7b of the pen grip 7 abuts the stepped portion 3, since the length L of the pen grip 7 is substantially equal to the length 1 of the small-diameter portion 4, the pen tip 5 and the tapered portion 4a will protrude outwardly from the opening 7c opened on the other side of the pen grip 7. Further, the cap 8 is fixed to the pen body 1 by screwing the external thread formed on the outer surface of the tapered portion 4a into the inner thread formed on the inner wall of the cap 8. As a result, by the stepped portion 3 of the pen body 1 and the cap 8, not only movement of the weight adjusting members 6 fitted onto the small-diameter portion 4 in the longitudinal direction can be restricted, but also the weight adjusting members 6 can be prevented from falling out of the pen body 1.

A configuration is possible in which a plurality of the aluminums 11, a plurality of the stainless steels 12 and a plurality of the spacers 13 are mounted to the small-diameter portion 4 of the pen body 1. With such a configuration, the aluminums 11, the stainless steels 12 and the spacers 13 having different weights can be mounted to the small-diameter portion 4 of the pen body 1, in any combination, according to the user's preference. At this time, the pen grip 7 has both the function of securing the aluminums 11, the stainless steels 12 and the spacers 13, and the function of improving the grip feeling. Further, since the weight adjusting members 6 are configured by combining a plurality of aluminums (1 g), stainless steels (2 g) and spacers (0 g) having different weights, not only the position of the center of gravity of the electronic stylus pen can be changed, but also the weight of the electronic stylus pen can be adjusted.

In such a configuration, since an arbitrary number of the weight adjusting members 6 are fitted onto the small-diameter portion 4, the length of the plurality of weight adjusting members 6 in the longitudinal direction may not exactly equal the length 1 of the small-diameter portion 4. As a result, a slight clearance may be generated between the weight adjusting members 6, and/or between the weight adjusting members 6 and the stepped portion 3, and/or between the weight adjusting members 6 and the cap 8. Thus, when the electronic stylus pen is being used by the user, the weight adjusting members 6 may otherwise move between the stepped portion 3 and the cap 8 so as to hit each other, to therefore an unpleasant noise. However, in the present embodiment, since the weight adjusting members 6 can be completely fixed (secured) by covering the pen grip 7 thereon, the unpleasant noise can be prevented.

Note that, although the stepped portion 3 is formed by making the diameter of the small-diameter portion 4 smaller than the diameter of the remaining portion of the pen body 1 in the present embodiment, the stepped portion is not necessarily formed in this manner. For example, the stepped portion may also be formed by forming a projected portion projecting outwardly in the radial direction from the pen body 1, instead of forming the small-diameter portion 4. Also, although the stepped portion 3 is arranged in the central portion of the pen body 1 in the present embodiment, the stepped portion can be arranged in any position according to each application. For example, in the case where it is desired to extend the adjustable range of the weight or to further move the center of gravity closer to the side of the pen tail 2, the position of the stepped portion 3 can be arranged closer to the pen tail 2, and the length 1 of the small-diameter portion 4 can be increased to allow more weight adjusting members 6 to be mounted thereon, so that the center of gravity can be adjusted closer to the pen tail 2 by an adjustment method (which is to be described later).

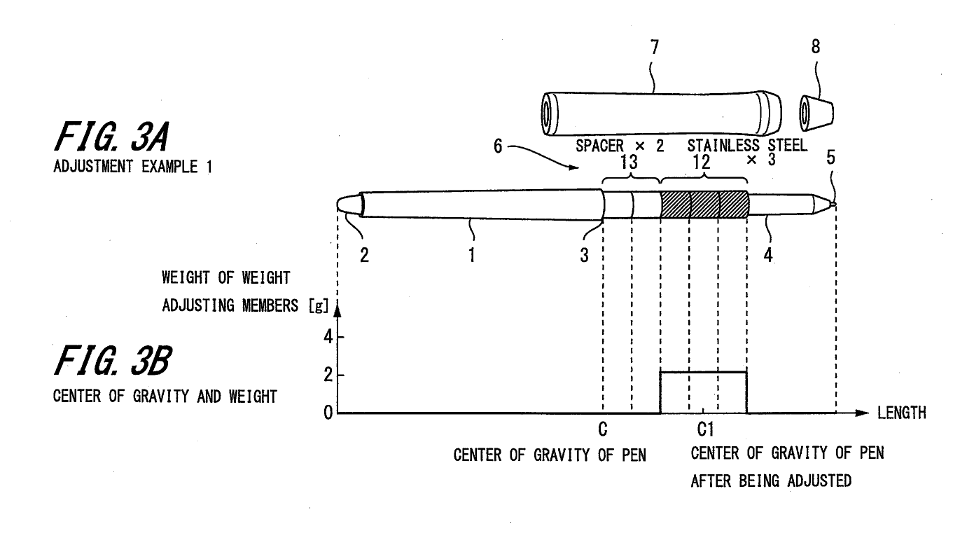

Next, an adjustment example 1 in which the center of gravity of the pen is moved closer to the pen tip side will be described below with reference to FIGS. 3A and 3B. In the adjustment example 1 shown in FIGS. 3A and 3B, two spacers 13 and three stainless steels 12 (as the weight adjusting members 6) are mounted to the small-diameter portion 4 in the area between the stepped portion 3 and the pen tip 5.

Since the weight of the two spacers 13 is apparently 0 g and the weight of the three stainless steels 12 is 2 g×3=6 g, the total weight of the electronic stylus pen is increased by 6 g.

Further, the center of gravity C of the electronic stylus pen before being adjusted is located at the position of the stepped portion 3 formed in the central portion of the pen body 1. In contrast, the center of gravity C1 of the electronic stylus pen after being adjusted by mounting a combination of two spacers 13 and three stainless steels 12 is located at a position in the central portion of the three stainless steels 12. In this manner, the center of gravity of the electronic stylus pen is moved closer to the pen tip 5 from C (the center of gravity before being adjusted) to C1 (the center of gravity after being adjusted).

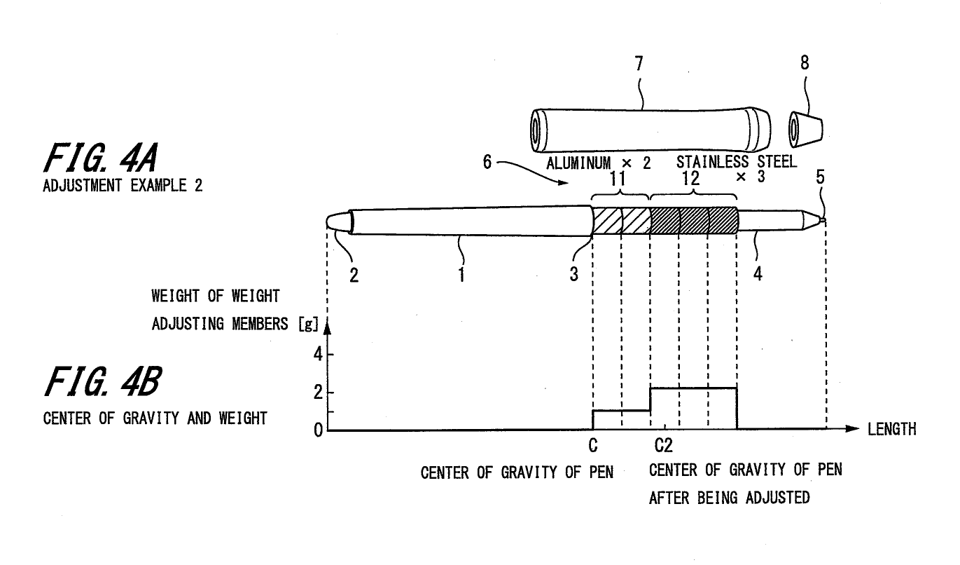

Next, an adjustment example 2 in which the center of gravity of the pen is moved closer to the pen tip side while the weight of the pen is increased will be described below with reference to FIGS. 4A and 4B. In the adjustment example 2 shown in FIGS. 4A and 4B, two aluminums 11 and three stainless steels 12 (as the weight adjusting members 6) are mounted to the small-diameter portion 4 in the area between the stepped portion 3 and the pen tip 5.

At this time, since the weight of the two aluminums 11 is 1 g×2=2 g, and the weight of the three stainless steels 12 is 2 g×3=6 g, the weight of the electronic stylus pen is increased by 8 g.

Further, as shown in FIG. 4B, the center of gravity C2 of the electronic stylus pen after being adjusted by mounting a combination of two aluminums 11 and three stainless steels 12 is located at a position in the central portion of the first (from the side of the pen tail 2) of the three stainless steels 12. In other word, by being adjusted in such a manner, the center of gravity of the electronic stylus pen is moved closer to the pen tip 5 from C (the center of gravity before being adjusted) to C2 (the center of gravity after being adjusted).

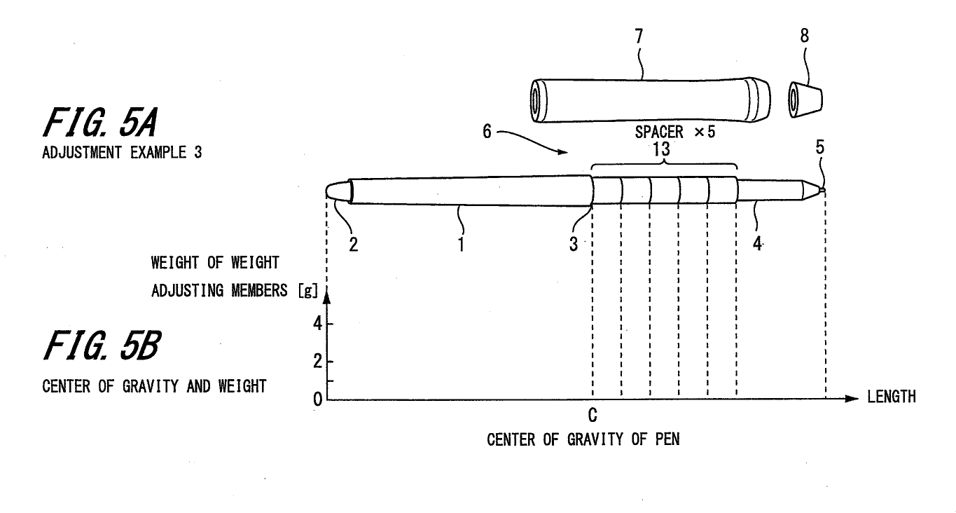

Next, an adjustment example 3 in which neither the center of gravity or the weight of the pen is adjusted will be described below with reference to FIG. 5A and FIG. 5B. In the adjustment example 3 shown in FIGS. 5A and 5B, five spacers 13 (as the weight adjusting members 6) are mounted to the small-diameter portion 4 in the area between the stepped portion 3 and the pen tip 5. Here, as described above, since the weight of the spacer 13 is 0 g, the weight of the five spacers 13 is apparently 0 g. Thus, the weight of the electronic stylus pen is actually unchanged. Accordingly, the position of the center of gravity of the electronic stylus pen does not change after being adjusted.

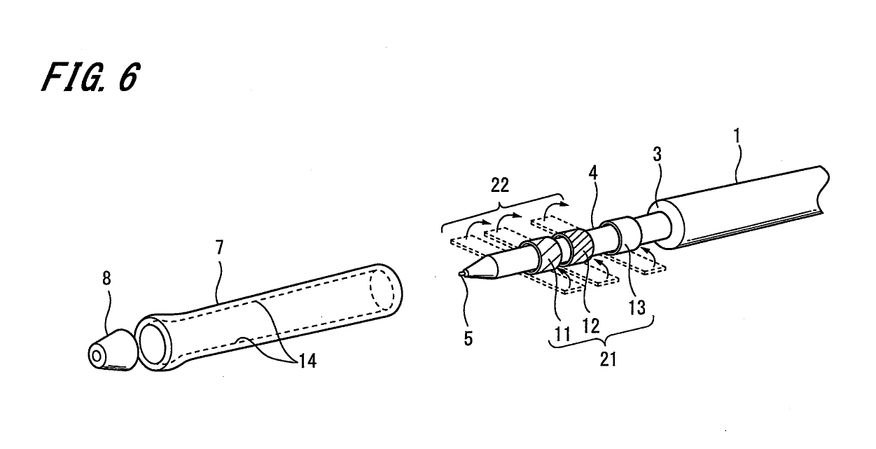

Next, mounting of a wrapping-type weight adjusting member 21 will be described below with reference to FIG. 6. The wrapping-type weight adjusting members 21 are composed of, for example, a plurality of aluminums 11, a plurality of stainless steels 12 and a plurality of spacers 13, and are wrapped around the small-diameter portion 4 of the pen body 1. The wrapping-type weight adjusting members 21 are each formed in a plate shape 22 indicated by the dotted line shown in FIG. 6 before being wrapped around the small-diameter portion 4, and are each maintained in a tubular shape indicated by the solid line shown in FIG. 6 after being wrapped around the small-diameter portion 4. The wrapping-type weight adjusting members 21 are each made of a material containing so-called irreversible component.

Similar to the cylindrical weight adjusting members 6, the wrapping-type weight adjusting members 21 are mounted at arbitrary positions of the small-diameter portion 4 in the area between the stepped portion 3 and the pen tip 5. Further, the wrapping-type weight adjusting members 21 having been mounted to the small-diameter portion 4 are covered by the pen grip 7. At this time, the aluminum 11, the stainless steel 12 and the spacer 13 constituting the wrapping-type weight adjusting members 21 are fixed in respective positions by the fixing portion 14 inside of the pen grip 7.

Similar to the case shown in FIG. 2, a configuration is possible in which a plurality of aluminums 11, a plurality of stainless steels 12 and a plurality of spacers 13 are wrapped around the small-diameter portion 4 of the pen body 1. With such a configuration, the tubular aluminums 11, the stainless steels 12 and the spacers 13 having different weights can be wrapped around the small-diameter portion 4 of the pen body 1, in any combination, according to the user's preference.

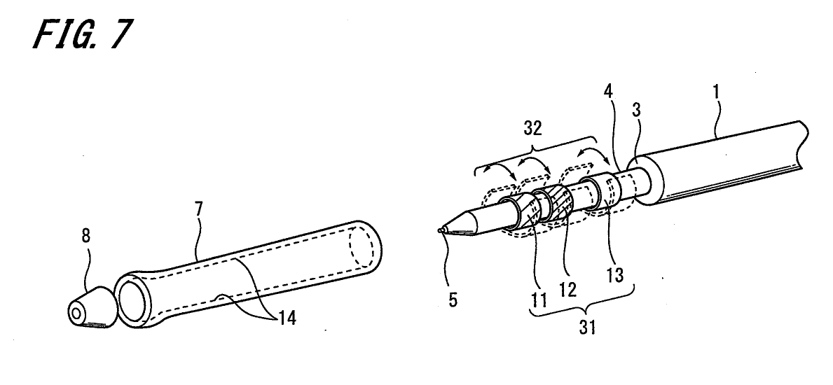

Next, mounting of a fitting-type weight adjusting member 31 will be described below with reference to FIG. 7.

The fitting-type weight adjusting members 31 are also composed of a plurality of aluminums 11, a plurality of stainless steels 12 and a plurality of spacers 13, and are fitted on the small-diameter portion 4 of the pen body 1. The fitting-type weight adjusting members 31 are each a flexible member which has a tubular shape indicated by the solid line of FIG. 7 before being fitted on the small-diameter portion 4. The tubular shape is then expanded (enlarged) so as to have a diameter larger than that of the small-diameter portion 4 as indicated by the dotted line of FIG. 6 when being fitted on the small-diameter portion 4. Once fitted on the small-diameter portion 4, the tubular shape is restored to the original shape indicated by the solid line. The fitting-type weight adjusting members 31 are each fitted on the small-diameter portion 4 at an arbitrary position in the area between the stepped portion 3 and the pen tip 5, and the fitted weight adjusting members 31 are covered by the pen grip 7. The fitting-type weight adjusting members 31 (the plurality of aluminum 11, stainless steel 12 and spacer 13) are fixed to the small-diameter portion 4 of the pen body 1 by the fixing portion 14 inside the pen grip 7.

Similar to the cases shown in FIGS. 2 and 6, a configuration is possible in which a plurality of aluminums 11, a plurality of stainless steels 12 and a plurality of spacers 13 constituting the fitting-type weight adjusting members 31 shown in FIG. 7 are fitted on the small-diameter portion 4 of the pen body 1. With such a configuration, the aluminums 11, the stainless steels 12 and the spacers 13 having different weights can be fitted on the small-diameter portion 4 of the pen body 1, in any combination, according to the user's preference.

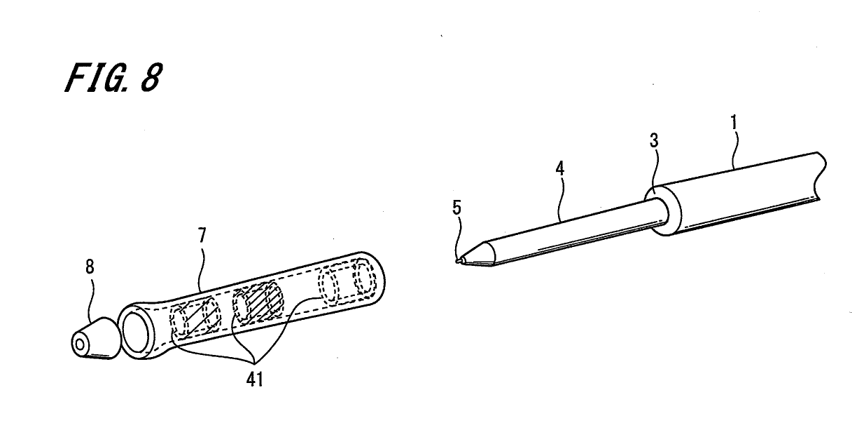

Next, an example in which weight adjusting members inside the pen grip are integrated with the pen grip will be described below with reference to FIG. 8. Weight adjusting members 41 on the inner surface of the pen grip 7 are integrated with the pen grip 7. In this example, the weight adjusting members 41 are identical to the weight adjusting members 6 composed of the aluminum 11, the stainless steel 12 and the spacer 13 as shown in FIG. 2.

Further, instead of being limited to such a configuration, there is a possible configuration in which components corresponding to the plurality of weighting members such as the aluminum (1 g), the stainless steel (2 g) and the like and a component corresponding to the dummy member such as the spacer (0 g) are kneaded (embedded) into the component of the pen grip 7 (such as rubber, resin or the like) from the inner surface of the pen grip 7 so as to be integrated with the pen grip 7.

The pen grip 7 integrated with the weight adjusting member 41 can also be attached to and detached from the small-diameter portion 4 of the pen body 1. Further, a pen grip 7 having a particular weight and/or weight balance can be made by adjusting the weight of the weight adjusting members 41 arranged inside the pen grip 7, and the pen grip 7 made in such a manner can be attached to and detached from the small-diameter portion 4 of the pen body 1.

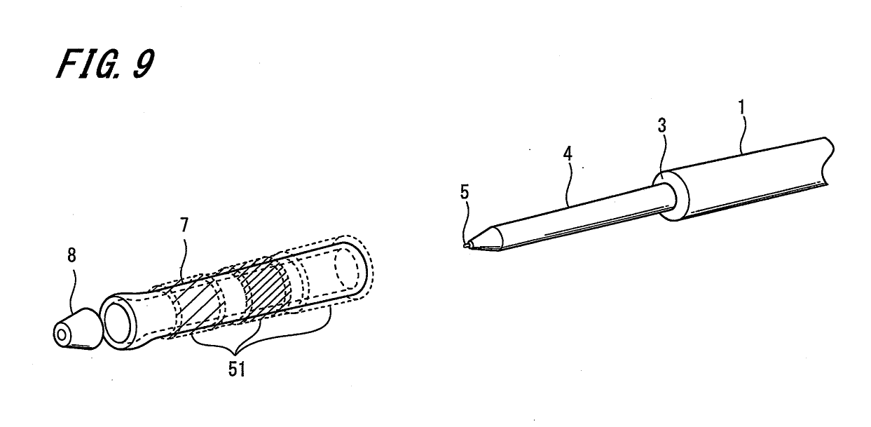

Next, an example in which weight adjusting members outside the pen grip are integrated with the pen grip will be described below with reference to FIG. 9.

Weight adjusting members 51 are wrapped around the pen grip 7 from outside so as to be integrated with the pen grip 7. The weight adjusting members 51 outside the pen grip 7 are also composed of the aluminum 11, the stainless steel 12 and the spacer 13, as shown in FIG. 2 and so on.

Further, instead of being limited to such a configuration, there is a possible configuration in which components corresponding to the plurality of weighting members such as the aluminum (1 g), the stainless steel (2 g) and the like and a component corresponding to the dummy member such as the spacer (0 g) are kneaded (or embedded) into the component of the pen grip 7 (such as rubber, resin or the like) from the outer side of the pen grip 7.

In such a case, the pen grip 7 integrated with the weight adjusting members 51 formed on the outer side thereof can also be attached to and detached from the small-diameter portion 4 of the pen body 1. Thus, a pen grip 7 having a particular weight and center of gravity can be made by adjusting the weight of the weight adjusting members 51 on the outer side thereof, and the pen grip 7 made in such a manner can be attached to and detached from the small-diameter portion 4 of the pen body 1. Thus, the position of the center of gravity and the weight can be adjusted according to the user's preference.

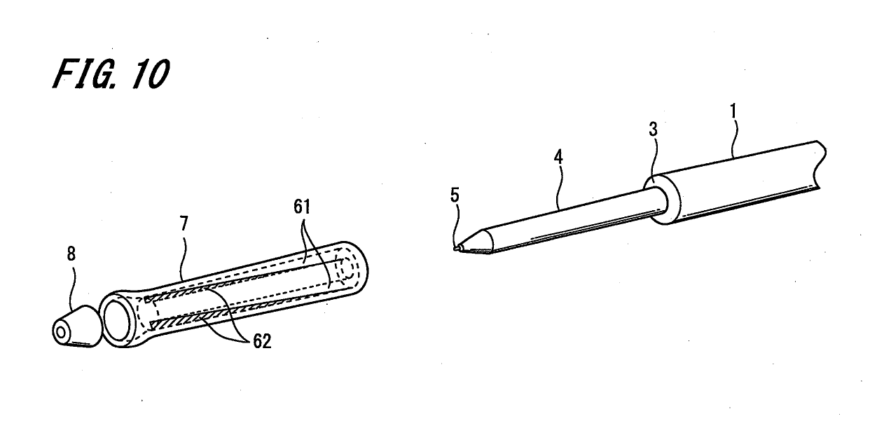

Next, an example in which a pen grip having a liquid or granular weight adjusting member filled into a tubular (annular) cavity thereof will be described below with reference to FIG. 10.

The pen grip 7 having the liquid or granular weight adjusting member filled into the tubular cavity thereof is provided, in the interior thereof, with a tubular cavity 61, into which a liquid or granular weight adjusting member 62 is filled. The liquid or granular weight adjusting member 62 is composed of, for example, liquid (such as water, viscous oil or the like), granules (such as granular aluminum, granular stainless steel or the like) or powder (such as sand or the like) for forming the plurality of weighting members, and gas (such as air), granules or powder (such as granular styrofoam) for forming the dummy member.

The pen grip 7 integrated with the liquid or granular weight adjusting member 62 can be attached to and detached from the small-diameter portion 4 of the pen body 1. Further, the pen grip 7 is made by adjusting the liquid or granular weight adjusting member 62 filled into the tubular cavity 61. In such a case, the position of the center of gravity of the pen can be adjusted by changing the moving state of the liquid or granular weight adjusting member 62 filled in the tubular cavity 61 formed inside the pen grip 7. Specifically, when the pen grip 7 is inclined toward the side of the pen tip 5, the liquid or granular weight adjusting member 62 is moved in its entirety closer to a tip end side of the tubular cavity 61. In contrast, when the pen grip 7 is inclined toward the side of the stepped portion 3, the liquid or granular weight adjusting member 62 is moved in its entirety closer to a rear end side of the tubular cavity 61.

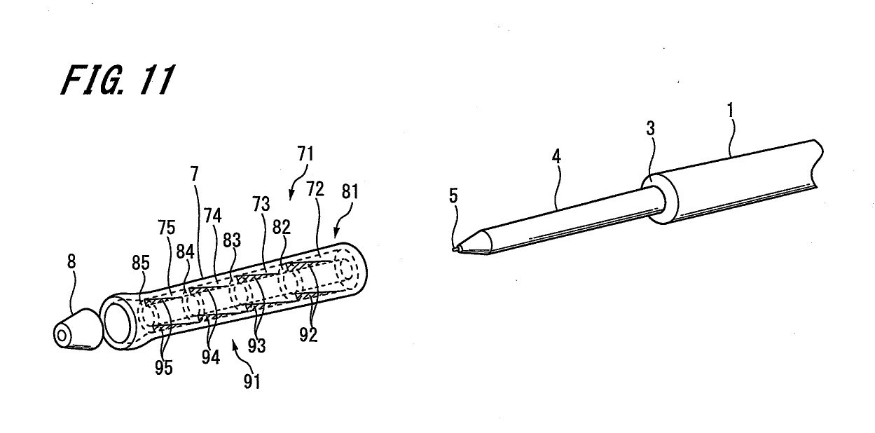

Next, an example in which a pen grip 7 having a liquid or granular weight adjusting member filled into a plurality of tubular cavities thereof will be described below with reference to FIG. 11.

The pen grip 7 has a liquid or granular weight adjusting member 91 filled into a tubular cavity 71 formed inside thereof. The liquid or granular weight adjusting member 91 is composed of, for example, liquid (such as water, viscous oil or the like), granules (such as granular aluminum, granular stainless steel or the like) or powder (such as sand or the like) for forming the plurality of weighting members, and gas (such as air), granules or powder (such as granular styrofoam) for forming the dummy member.

The tubular cavity 71 is partitioned into plural cavities 72, 73, 74 and 75 by a partition 81. Specifically, the cavity 72 and the cavity 73 are partitioned by a partition 82; the cavity 73 and the cavity 74 are partitioned by a partition 83; and the cavity 74 and the cavity 75 are partitioned by a partition 84. Further, an end of the cavity 72 on the side of the stepped portion 3 is hermetically-sealed, and an end of the cavity 75 on the side of the pen tip is partitioned by a partition 85.

The pen grip 7 integrated with the liquid or granular weight adjusting member 91 can be attached to and detached from the small-diameter portion 4 of the pen body 1. Thus, suitable adjustment can be made according to the user's preference by adjusting the weight of the liquid or granular weight adjusting member 91 and attaching/detaching the pen grip 7 to/from the small-diameter portion 4 of the pen body 1.

In such a case, adjustment can be changed by changing the moving state of the liquid or granular weight adjusting member 91 filled in the tubular cavity 71 formed inside the pen grip 7. Specifically, when the pen grip 7 is inclined toward the side of the pen tip 5, the liquid or granular weight adjusting member 91 filled into the cavities 72, 73, 74, 75 of the tubular cavity 71 can be respectively moved toward the partition 81 arranged on tip end sides of the cavities 72, 73, 74, 75.

In contrast, when the pen grip 7 is inclined toward the side of the stepped portion 3, the liquid or granular weight adjusting member 91 filled into the cavities 72, 73, 74, 75 of the tubular cavity 71 can be respectively moved toward the partition 81 arranged on rear end sides of the cavities 72, 73, 74, 75.

In accordance with various embodiments of the present invention, the weight adjusting members 6 shown in FIG. 2, the wrapping-type weight adjusting members 21 shown in FIG. 6, the fitting-type weight adjusting members 31 shown in FIG. 7, the weight adjusting members 41 arranged inside the pen grip 7 shown in FIG. 8, the weight adjusting members 51 arranged outside the pen grip 7 shown in FIG. 9, the liquid or granular weight adjusting member 62 shown in FIG. 10, and the liquid or granular weight adjusting member 91 shown in FIG. 11 all should be made of materials which do not affect the function of the pen tip 5.

In other words, when the aforesaid pen is used as the electronic stylus pen which performs input detection for a digitizer based on electromagnetic induction, the aforesaid weight adjusting members need to be made of materials which do not affect the electromagnetic induction effect.

Specifically, when the aforesaid pen is used as the electronic stylus pen which performs input detection for a digitizer based on electromagnetic induction, since the pen tip 5 is provided with a magnetic core, the aforesaid weight adjusting members need to be made of materials which do not interfere with the electromagnetic induction effect caused by the magnetic core.

It should be noted that the present invention is not limited to the above embodiments but can be properly modified without departing from the spirit of the present invention.

What is claimed is:

1. An electronic stylus pen with weight adjusting mechanism comprising:
one or more weight adjusting members; and
an elongate pen body having a mounting portion to which one or more of the weight adjusting members are detachably mounted at arbitrary positions of the mounting portion.

2. The electronic stylus pen with weight adjusting mechanism according to claim 1, further comprising:
a pen tip arranged on one end of the pen body in longitudinal direction; and
a regulating portion for regulating movement of the weight adjusting members in the longitudinal direction of the pen body,
wherein the mounting portion is arranged between the regulating portion and the pen tip.

3. The electronic stylus pen with weight adjusting mechanism according to claim 1, further comprising a covering portion for securing the weight adjusting members by covering the mounting portion and the weight adjusting members.

4. The electronic stylus pen with weight adjusting mechanism according to claim 1, wherein the diameter of the mounting portion is smaller than that of the remaining portion of the pen body.

5. The electronic stylus pen with weight adjusting mechanism according to claim 1, wherein the weight adjusting members include a plurality of weighting members and dummy members.

6. The electronic stylus pen with weight adjusting mechanism according to claim 5, wherein the position of the center of gravity of the pen body can be changed by combining the plurality of weighting members and dummy members.

7. The electronic stylus pen with weight adjusting mechanism according to claim 1, wherein the weight adjusting members are wrapped around the mounting portion.

8. The electronic stylus pen with weight adjusting mechanism according to claim 1, wherein the weight adjusting members are fitted on the mounting portion.

9. The electronic stylus pen with weight adjusting mechanism according to claim 3, wherein the covering portion is integrated with the weight adjusting members and can be attached to and detached from the mounting portion.

10. The electronic stylus pen with weight adjusting mechanism according to claim 9, wherein the weight adjusting members comprise a liquid or granular weight adjusting member filled into the covering portion.

11. The electronic stylus pen with weight adjusting mechanism according to claim 2, wherein the weight adjusting members are made of materials which do not affect the function of the pen tip.

12. The electronic stylus pen with weight adjusting mechanism according to claim 11, wherein the pen tip is provided with a magnetic core, and the weight adjusting members are made of the materials which do not interfere with electromagnetic induction effect caused by the magnetic core.
